(19) United States
(12) Patent Application Publication
(10) Pub. No.: US 2023/0167231 A1
(43) Pub. Date: Jun. 1, 2023

(54) POLYESTER AND COATING MATERIAL

(71) Applicant: INDUSTRIAL TECHNOLOGY RESEARCH INSTITUTE, Hsinchu (TW)

(72) Inventors: Yuan-Chang HUANG, Hsinchu City (TW); Yi-Che SU, Zhubei City (TW); Wen-Yang CHEN, Qionglin Township (TW); Yi-Tzu PENG, Huwei Township (TW)

(73) Assignee: INDUSTRIAL TECHNOLOGY RESEARCH INSTITUTE, Hsinchu (TW)

(21) Appl. No.: 17/679,429

(22) Filed: Feb. 24, 2022

(30) Foreign Application Priority Data
Nov. 26, 2021 (TW) 110144137

(51) Int. Cl. C08G 63/16; C08G 63/66; C09D 167/02; C08K 5/3492

(52) U.S. Cl. CPC C08G 63/16; C08G 63/66; C09D 167/025; C08K 5/34922; C08G 2150/00

(57) ABSTRACT

A polyester is formed by reacting a plurality of monomers. The monomers include 7 to 20 parts by mole of (a) aliphatic triol monomer, 40 to 80 parts by mole of (b) first diol monomer, 12 to 40 parts by mole of (c) second diol monomer, and 100 parts by mole of (d) aliphatic diacid monomer or aliphatic anhydride monomer. The (b) first diol monomer has a chemical structure of

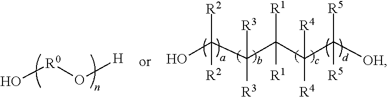

wherein each R¹ is the same. The (c) second diol monomer has a chemical structure of

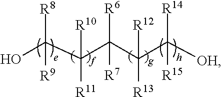

wherein R⁶ is different from R⁷.

### CROSS REFERENCE TO RELATED APPLICATIONS

The present application is based on, and claims priority from, Taiwan Application Serial Number 110144137, filed on 26 Nov. 2021, the disclosure of which is hereby incorporated by reference herein in its entirety.

### TECHNICAL FIELD

The technical field relates to a polyester.

### BACKGROUND

Polyester is often used as one component of coating material. The price of conventional polyester is low due to its poor weather-resistance. A fast way to increase the value of polyester would be to improve its weather-resistance. On the other hand, reducing volatile organic compounds (VOC) is a global trend, and laws in the EU laws and the US state of California require reductions in the VOC of coating materials. However, the VOC of such coating material mainly comes from the solvent, and reducing the solvent may increase the viscosity of the coating material. A coating material with too high viscosity may not be useable. Accordingly, a novel polyester for manufacturing a polyester coating material with a high solid content (low VOC), low viscosity, high biomass content, and high weather-resistance is called for to increase the value of the polyester.

### SUMMARY

One embodiment of the disclosure provides a polyester formed by reacting a plurality of monomers. The monomers include: 7 to 20 parts by mole of (a) aliphatic triol monomer; 40 to 80 parts by mole of (b) first diol monomer; 12 to 40 parts by mole of (c) second diol monomer; and 100 parts by mole of (d) aliphatic diacid monomer or aliphatic anhydride monomer, wherein (b) first diol monomer has a chemical structure of

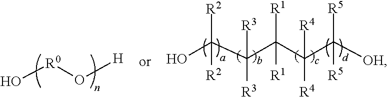

wherein n is an integer of 2 to 10, each of a, b, c, and d is independently an integer of 0 to 6, and a+b+c+d≠0, R⁰ is C₂₋₅ alkylene group, R¹ is H or C₁₋₆ alkyl group, and each of R¹ is the same; R² is H or C₁₋₆ alkyl group, and each of R² is the same; R³ is H or C₁₋₆ alkyl group, and each of R³ is the same; R⁴ is H or C₁₋₆ alkyl group, and each of R⁴ is the same; and R⁵ is H or C₁₋₆ alkyl group, and each of R⁵ is the same; and wherein (c) second diol monomer has a chemical structure of

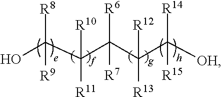

wherein each of e, f, g, and h is independently an integer of 0 to 6, and e+f+g+h≠0; and R⁶ is H or C₁₋₆ alkyl group, R⁷ is H or C₁₋₆ alkyl group, and R⁶ is different from R⁷; and each of R⁸, R⁹, R¹⁰, R¹¹, R¹², R¹³, R¹⁴, and R¹⁵ is independently H or C₁₋₆ alkyl group.

One embodiment of the disclosure provides a coating material, including 100 parts by weight of the described polyester; and 5 to 40 parts by weight of a curing agent.

A detailed description is given in the following embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

One embodiment of the disclosure provides a polyester formed by reacting a plurality of monomers, and the monomers include: 7 to 20 parts by mole of (a) aliphatic triol monomer; 40 to 80 parts by mole of (b) first diol monomer; 12 to 40 parts by mole of (c) second diol monomer; and 100 parts by mole of (d) aliphatic diacid monomer or aliphatic anhydride monomer.

In some embodiments, (a) aliphatic triol monomer includes glycerin, trimethylolpropane, trimethylolethane, polycaprolactone triol, stigmastane-3,5,6-triol, (5alpha)-cholestane-3,5,6-triol, an ethoxylated or propoxylated derivative thereof, or a combination thereof. If the amount of (a) aliphatic triol monomer is too low, the molecular weight of the polyester will be too low or the durability of the polyester will be insufficient. If the amount of (a) aliphatic triol monomer is too high, the viscosity of the polyester will be too high or the reaction product of esterification will gel.

The described (b) first diol monomer has a chemical structure of

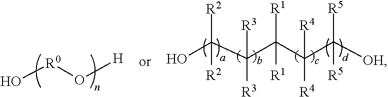

wherein n is an integer of 2 to 10, each of a, b, c, and d is independently an integer of 0 to 6, and a+b+c+d≠0, R⁰ is C₂₋₅ alkylene group, R¹ is H or C₁₋₆ alkyl group, and each of R¹ is the same; R² is H or C₁₋₆ alkyl group, and each of R² is the same; R³ is H or C₁₋₆ alkyl group, and each of R³ is the same; R⁴ is H or C₁₋₆ alkyl group, and each of R⁴ is the same; and R⁵ is H or C₁₋₆ alkyl group, and each of R⁵ is the same. In some embodiments, (b) first diol monomer includes ethylene glycol, propylene glycol, neopentyl glycol, 1,4-butanediol, diethylene glycol, dipropylene glycol, tripropylene glycol, or a combination thereof. If the amount of (b) first diol monomer is too low, the polyester will have an insufficient molecular weight and poor physical properties including its hardness. If the amount of (b) first diol monomer is too high, the polyester will have too high viscosity or poor weather-resistance.

The described (c) second diol monomer has a chemical structure of

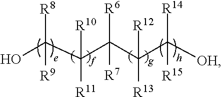

wherein each of e, f, g, and h is independently an integer of 0 to 6, and e+f+g+h≠0; and R⁶ is H or C₁₋₆ alkyl group, R⁷ is H or C₁₋₆ alkyl group, and R⁶ is different from R⁷; and each of R⁸, R⁹, R¹⁰, R¹¹, R¹², R¹³, R¹⁴, and R¹⁵ is independently H or C₁₋₆ alkyl group. In some embodiments, (c) second diol monomer includes 2-butyl-2-ethyl-1,3-propanediol, 1,2-propanediol, 1,3-butanediol, 2-methyl-2,4-petanediol, 2-methyl-2-propyl-1,3-propanediol, or a combination thereof. If the amount of (c) second diol monomer is too low, the polyester will have too high viscosity. If the amount of (c) second diol monomer is too high, the polyester will have a low molecular weight, which will result in the polyester having insufficient physical properties.

In some embodiments, the described (d) aliphatic diacid monomer or aliphatic anhydride monomer includes hydrogenated phthalic anhydride, dodecenylsuccinic anhydride, hexahydro-4-methylphthalic anhydride, methylsuccinic anhydride, itaconic anhydride, 2,3-dimethylmaleic anhydride, succinic acid, oxalic acid, malonic acid, glutaric acid, adipic acid, suberic acid, azelaic acid, sebacic acid, dodecanedioic acid, thapsic acid, itaconic acid or a combination thereof.

In some embodiments, (a) aliphatic triol monomer, (b) first diol monomer, (d) aliphatic diacid monomer or aliphatic anhydride monomer, or a combination thereof is a biomass material. For example, (a) aliphatic triol monomer can be biomass glycerin, (b) first diol monomer can be biomass ethylene glycol, and (d) aliphatic diacid monomer or aliphatic anhydride monomer can be biomass sebacic acid or itaconic acid. When the monomer is the biomass material, the biomass content of the polyester can be increased. For example, the biomass content of the polyester can be increased to >25% for meeting the requirement of BioPreferred label standard (>22%).

In some embodiments, the polyester has a weight average molecular weight (Mw) of 4500 to 90000. The Mw of the polyester can be measured by gel permeation chromatography (GPC) with polystyrenes (having Mw of 498, 1220, 8670, 19100, 62500, 125000, 554000, and 1170000) as standard. If the Mw of the polyester is too low, the polyester will have poor weather-resistance and physical properties. If the Mw of the polyester is too high, viscosity of the polyester will be too high or the esterification reaction mixture will gel. In some embodiments, the polyester can be applied as a coating material. When the polyester is diluted by xylene to a solid content of 75 wt %, it has a Gardner-Holdt viscosity of Y to Z3 at 25° C. Note that the Gardner-Holdt viscosity of the polyester is measured according to the standard CNS 15200-2-2. If the Gardner-Holdt viscosity of the diluted polyester (75 wt %) is too low, the paint runs may occur easily. If the Gardner-Holdt viscosity of the diluted polyester (75 wt %) is too high, the diluted polyester cannot be coated. In addition, the polyester in some embodiments has a Gardner-Holdt viscosity of X to Z3, which can be applied as ink, adhesive, or glass fiber reinforced plastic.

In some embodiments, the polyester has a signal integral value C1 from 39 ppm to 40 ppm in a carbon spectrum (¹³C NMR), a signal integral value C2 from 37 ppm to 39 ppm in the carbon spectrum, and a signal integral value C3 from 33 ppm to 35 ppm in the carbon spectrum. C1 corresponds to one ester group formed by reacting one (a) aliphatic triol monomer and one (d) aliphatic diacid monomer or aliphatic anhydride monomer. C2 corresponds to two ester groups formed by reacting one (a) aliphatic triol monomer and two (d) aliphatic diacid monomers or aliphatic anhydride monomers. C3 corresponds to three ester groups formed by reacting one (a) aliphatic triol monomer and three (d) aliphatic diacid monomers or aliphatic anhydride monomers. The degree of esterification E (e.g. the degree of cross-linking) can be defined as E=(C1+2*C2+3*C3)/(C1+C2+C3), and E can be 2.07 to 2.50. When E is less than 2.07, it means that the esterification degree is too low. If the degree of esterification is insufficient, the coating layer formed from the coating material will have a poor weather-resistance. When E is higher than 2.50, it means that the degree of esterification is high. If the degree of esterification is too high, the viscosity of the polyester will be too high or the esterification reaction mixture will gel.

It should be understood that appropriate amounts of (a) aliphatic triol monomer, (b) first diol monomer, (c) second diol monomer, and (d) aliphatic diacid monomer or aliphatic anhydride monomer can be mixed and then heated to 150° C. to 230° C. and reacted for 4 hours to 24 hours to form the polyester. In addition, the reaction can be performed under vacuum at a lower reaction temperature with a shorter reaction period to achieve the similar effect. Note that if the heating temperature is too high, the reaction period is too long, or the vacuum degree is too high, the degree of esterification of (a) aliphatic triol monomer will be too high. If the heating temperature is too low or the reaction period is too short, the degree of esterification of (a) aliphatic triol monomer will be insufficient. Note that the described method is only for illustration rather than limiting the disclosure. One skilled in the art may select applicable steps and process parameters to complete the polymerization.

One embodiment of the disclosure provides a coating material, including 100 parts by weight of the described polyester and 5 to 40 parts by weight of a curing agent. In some embodiments, the curing agent includes melamine or isocyanate. The melamine is usually used at high temperature (e.g. 120° C. to 270° C.), and the isocyanate is usually used at low temperature (10° C. to 100° C.). If the curing agent amount is too low, the coating layer has poor physical properties (e.g. hardness or weather-resistance). If the curing agent amount is too high, the coating layer will be too soft or cannot be formed.

In some embodiments, the coating material may further includes 10 to 30 parts by weight of a solvent. For example, the solvent includes xylene, toluene, aromatic naphtha, ethyl acetate, butyl acetate, methyl isobutyl ketone, acetone, tetrahydrofuran, cyclohexane, cyclohexanone, or a combination thereof. If the solvent is too much, the solid content of the coating material will be decreased and the volatile organic compound (VOC) will be increased. The coating material of the disclosure may simultaneously have high solid content and low viscosity, and the coating layer formed from the coating material may have high weather-resistance and high mechanical strength (e.g. bend resistance and hardness).

Below, exemplary embodiments will be described in detail so as to be easily realized by a person having ordinary knowledge in the art. The inventive concept may be embodied in various forms without being limited to the exemplary embodiments set forth herein. Descriptions of well-known parts are omitted for clarity.

### EXAMPLES

### Example 1

12 g of trimethylolpropane (0.09 mole), 24 g of ethylene glycol (0.39 mole), 36 g of neopentyl glycol (0.35 mole), 60 g of 2-ethyl-2-butylpropanediol (0.37 mole), 192 g of hydrogenated phthalic anhydride (1.25 mole), and 0.3 g of tin(II) oxalate were mixed and then heated to 210° C. and reacted for 12 hours to form a polyester. Xylene was added to the reaction result to dilute it to a solid content of 75 wt %, which was analyzed by the standard CNS 15200-2-2 at room temperature (about 25° C.) to measure its Gardner-Holdt viscosity (Z, about 2300 cps). The polyester was analyzed by GPC with polystyrenes as standard to measure its weight average molecular weight (16885).

### Example 2

20 g of glycerin (0.22 mole), 30 g of ethylene glycol (0.48 mole), 30 g of neopentyl glycol (0.29 mole), 60 g of 2-ethyl-2-butylpropanediol (0.37 mole), 100 g of hydrogenated phthalic anhydride (0.65 mole), 96 g of succinic acid (0.81 mole), and 0.3 g of tin(II) oxalate were mixed and then heated to 210° C. and reacted for 12 hours to form a polyester. Xylene was added to the reaction result to dilute it to a solid content of 75 wt %, which was analyzed by the standard CNS 15200-2-2 at room temperature (about 25° C.) to measure its Gardner-Holdt viscosity (Z, about 2300 cps). The polyester was analyzed by GPC with polystyrenes as standard to measure its weight average molecular weight (11993).

### Example 3-1

30 g of trimethylolpropane (0.22 mole), 25 g of ethylene glycol (0.40 mole), 30 g of neopentyl glycol (0.29 mole), 70 g of 2-ethyl-2-butylpropanediol (0.44 mole), 190 g of hydrogenated phthalic anhydride (1.23 mole), and 0.3 g of tin(II) oxalate were mixed and then heated to 210° C. and reacted for 12 hours to form a polyester. Xylene was added to the reaction result to dilute it to a solid content of 75 wt %, which was analyzed by the standard CNS 15200-2-2 at room temperature (about 25° C.) to measure its Gardner-Holdt viscosity (Z, about 2300 cps). The polyester was analyzed by GPC with polystyrenes as standard to measure its weight average molecular weight (18667). The carbon spectrum (¹³C NMR) of the polyester was measured, which had a signal integral value C1 from 39 ppm to 40 ppm, a signal integral value C2 from 37 ppm to 39 ppm, and a signal integral value C3 from 33 ppm to 35 ppm. In Example 3-1, (C1+2*C2+3*C3)/(C1+C2+C3)=2.48.

20 g of a curing agent melamine (Allnex Cymel 303) and 37.5 g of TiO₂ (Chemours Ti-Pure R706) were added to 100 g of the polyester solution (having a solid content of 75 wt %), and then further diluted by xylene to form a coating material having a solid content of 75 wt %. The coating material was coated onto a galvanized steel plate, and then dried at 240° C. for 10 minutes to form a coating layer. The coating layer was tested by the standard CNS 10757 to measure its hardness (H), tested by the standard ASTM G154 Cycle 2 to measure its weather-resistance (brightness kept as 88% after being tested for 1000 hours), and tested by ASTM D4145 to measure its T-bend resistance (2T).

### Example 3-2

Example 3-2 was similar to Example 3-1, and the difference in Example 3-2 was the reaction period being decreased to 11.5 hours. The types and amounts of the reactants and the reaction temperature were same as those in Example 3-1. Xylene was added to the reaction result to dilute it to a solid content of 75 wt %, which was analyzed by the standard CNS 15200-2-2 at room temperature (about 25° C.) to measure its Gardner-Holdt viscosity (Z, about 2300 cps). The polyester was analyzed by GPC with polystyrenes as standard to measure its weight average molecular weight (12251). The carbon spectrum (¹³C NMR) of the polyester was measured, which had a signal integral value C1 from 39 ppm to 40 ppm, a signal integral value C2 from 37 ppm to 39 ppm, and a signal integral value C3 from 33 ppm to 35 ppm. In Example 3-2, (C1+2*C2+3*C3)/(C1+C2+C3)=2.17.

20 g of a curing agent melamine (Allnex Cymel 303) and 37.5 g of TiO₂ (Chemours Ti-Pure R706) were added to 100 g of the polyester solution (having a solid content of 75 wt %), and then further diluted by xylene to form a coating material having a solid content of 75 wt %. The coating material was coated onto a galvanized steel plate, and then dried at 240° C. for 10 minutes to form a coating layer. The coating layer was tested by the standard CNS 10757 to measure its hardness (3H), tested by the standard ASTM G154 Cycle 2 to measure its weather-resistance (brightness kept as 100% after being tested for 1000 hours), and tested by ASTM D4145 to measure its T-bend resistance (1T).

### Example 3-3

Example 3-3 was similar to Example 3-1, and the difference in Example 3-3 was the reaction period being decreased to 11 hours. The types and amounts of the reactants and the reaction temperature were same as those in Example 3-1. Xylene was added to the reaction result to dilute it to a solid content of 75 wt %, which was analyzed by the standard CNS 15200-2-2 at room temperature (about 25° C.) to measure its Gardner-Holdt viscosity (Z1, about 2500 cps). The polyester was analyzed by GPC with polystyrenes as standard to measure its weight average molecular weight (10251). The carbon spectrum (¹³C NMR) of the polyester was measured, which had a signal integral value C1 from 39 ppm to 40 ppm, a signal integral value C2 from 37 ppm to 39 ppm, and a signal integral value C3 from 33 ppm to 35 ppm. In Example 3-3, (C1+2*C2+3*C3)/(C1+C2+C3)=2.07.

20 g of a curing agent melamine (Allnex Cymel 303) and 37.5 g of TiO₂ (Chemours Ti-Pure R706) were added to 100 g of the polyester solution (having a solid content of 75 wt %), and then further diluted by xylene to form a coating material having a solid content of 75 wt %. The coating material was coated onto a galvanized steel plate, and then dried at 240° C. for 10 minutes to form a coating layer. The coating layer was tested by the standard CNS 10757 to measure its hardness (2H), tested by the standard ASTM G154 Cycle 2 to measure its weather-resistance (brightness kept as 85% after being tested for 1000 hours), and tested by ASTM D4145 to measure its T-bend resistance (1T).

### Example 3-4

Example 3-4 was similar to Example 3-1, and the differences in Example 3-4 were the reaction temperature being increased to 220° C. and the reaction period being decreased to 6 hours. The types and amounts of the reactants were same as those in Example 3-1. Xylene was added to the reaction result to dilute it to a solid content of 75 wt %, which was analyzed by the standard CNS 15200-2-2 at room temperature (about 25° C.) to measure its Gardner-Holdt viscosity (Z1, about 2500 cps). The polyester was analyzed by GPC with polystyrenes as standard to measure its weight average molecular weight (7881). The carbon spectrum (13C NMR) of the polyester was measured, which had a signal integral value C1 from 39 ppm to 40 ppm, a signal integral value C2 from 37 ppm to 39 ppm, and a signal integral value C3 from 33 ppm to 35 ppm. In Example 3-4, (C1+2*C2+3*C3)/(C1+C2+C3)=2.48.

20 g of a curing agent melamine (Allnex Cymel 303) and 37.5 g of TiO₂ (Chemours Ti-Pure R706) were added to 100 g of the polyester solution (having a solid content of 75 wt %), and then further diluted by xylene to form a coating material having a solid content of 75 wt %. The coating material was coated onto a galvanized steel plate, and then dried at 240° C. for 10 minutes to form a coating layer. The coating layer was tested by the standard CNS 10757 to measure its hardness (2H), and tested by ASTM D4145 to measure its T-bend resistance (1T).

### Example 4

20 g of biomass glycerin (0.22 mole), 37 g of ethylene glycol (0.60 mole), 45 g of neopentyl glycol (0.43 mole), 30 g of 2-ethyl-2-butylpropanediol (0.19 mole), 110 g of hydrogenated phthalic anhydride (0.71 mole), 95 g of biomass succinic acid (0.80 mole), and 0.3 g of tin(II) oxalate were mixed and then heated to 210° C. and reacted for 12 hours to form a polyester. Xylene was added to the reaction result to dilute it to a solid content of 75 wt %, which was analyzed by the standard CNS 15200-2-2 at room temperature (about 25° C.) to measure its Gardner-Holdt viscosity (Y, about 2000 cps). The polyester was analyzed by GPC with polystyrenes as standard to measure its weight average molecular weight (4880). The polyester was tested by the standard (ASTM D6866) to measure its biomass content (27.47%).

20 g of a curing agent melamine (Allnex Cymel 303) and 37.5 g of TiO₂ (Chemours Ti-Pure R706) were added to 100 g of the polyester solution (having a solid content of 75 wt %), and then further diluted by xylene to form a coating material having a solid content of 75 wt %. The coating material was coated onto a galvanized steel plate, and then dried at 240° C. for 10 minutes to form a coating layer. The coating layer was tested by the standard CNS 10757 to measure its hardness (3H), tested by the standard ASTM G154 Cycle 2 to measure its weather-resistance (brightness kept as 80% after being tested for 1000 hours), and tested by ASTM D4145 to measure its T-bend resistance (0T).

### Example 5

30 g of trimethylolpropane (0.22 mole), 32 g of ethylene glycol (0.52 mole), 70 g of 2-ethyl-2-butylpropanediol (0.44 mole), 190 g of hydrogenated phthalic anhydride (1.23 mole), and 0.3 g of tin(II) oxalate were mixed and then heated to 210° C. and reacted for 12 hours to form a polyester. Xylene was added to the reaction result to dilute it to a solid content of 75 wt %, which was analyzed by the standard CNS 15200-2-2 at room temperature (about 25° C.) to measure its Gardner-Holdt viscosity (X, about 1400 cps). The polyester was analyzed by GPC with polystyrenes as standard to measure its weight average molecular weight (5910).

### Comparative Example 1-1

10 g of trimethylolpropane (0.07 mole), 15 g of ethylene glycol (0.24 mole), 60 g of neopentyl glycol (0.58 mole), 15 g of 2-ethyl-2-butylpropanediol (0.09 mole), 160 g of hydrogenated phthalic anhydride (1.04 mole), and 0.3 g of tin(II) oxalate were mixed and then heated to 210° C. and reacted for 12 hours to form a polyester. Xylene was added to the reaction result to dilute it to a solid content of 75 wt %, which was analyzed by the standard CNS 15200-2-2 at room temperature (about 25° C.) to measure its Gardner-Holdt viscosity (Z4, about 6500 cps). The polyester was analyzed by GPC with polystyrenes as standard to measure its weight average molecular weight (1534). Because the amount of the second diol monomer was too low, the viscosity of the polyester was too high and the weight average molecular weight of the polyester was insufficient.

### Comparative Example 1-2

4 g of trimethylolpropane (0.03 mole), 20 g of ethylene glycol (0.32 mole), 60 g of neopentyl glycol (0.58 mole), 20 g of 2-ethyl-2-butylpropanediol (0.12 mole), 160 g of hydrogenated phthalic anhydride (1.04 mole), and 0.3 g of tin(II) oxalate were mixed and then heated to 210° C. and reacted for 12 hours to form a polyester. Xylene was added to the reaction result to dilute it to a solid content of 75 wt %. The polyester was analyzed by GPC with polystyrenes as standard to measure its weight average molecular weight (883). Because the amount of the second diol monomer was too low, the weight average molecular weight of the polyester was insufficient.

### Comparative Example 2

40 g of glycerin (0.43 mole), 41 g of ethylene glycol (0.66 mole), 40 g of neopentyl glycol (0.38 mole), 30 g of 2-ethyl-2-butylpropanediol (0.19 mole), 200 g of hydrogenated phthalic anhydride (1.30 mole), and 0.3 g of tin(II) oxalate were mixed and then heated to 210° C. and reacted for 12 hours. The reaction mixture gelled and its Gardner-Holdt viscosity and molecular weight could not be measured.

### Comparative Example 3-1

Comparative Example 3-1 was similar to Example 3-1, and the difference in Comparative Example 3-1 was the reaction period being decreased to 6 hours. The types and amounts of the reactants and the reaction period were same as those in Example 3-1. Xylene was added to the reaction result to dilute it to a solid content of 75 wt %, which was analyzed by the standard CNS 15200-2-2 at room temperature (about 25° C.) to measure its Gardner-Holdt viscosity (Z, about 2300 cps). The polyester was analyzed by GPC with polystyrenes as standard to measure its weight average molecular weight (9788). The carbon spectrum (¹³C NMR) of the polyester was measured, which had a signal integral value C1 from 39 ppm to 40 ppm, a signal integral value C2 from 37 ppm to 39 ppm, and a signal integral value C3 from 33 ppm to 35 ppm. In Comparative Example 3-1, (C1+2*C2+3*C3)/(C1+C2+C3)=2.04.

20 g of a curing agent melamine (Allnex Cymel 303) and 37.5 g of TiO₂ (Chemours Ti-Pure R706) were added to 100 g of the polyester solution (having a solid content of 75 wt %), and then further diluted by xylene to form a coating material having a solid content of 75 wt %. The coating material was coated onto a galvanized steel plate, and then dried at 240° C. for 10 minutes to form a coating layer. The coating layer was tested by the standard CNS 10757 to measure its hardness (3H), tested by the standard ASTM G154 Cycle 2 to measure its weather-resistance (brightness kept as <40% and peeled off after being tested for 1000 hours), and tested by ASTM D4145 to measure its T-bend resistance (2T). As shown above, the insufficient reaction period resulted in insufficient degree of esterification (e.g. the degree of cross-linking) of the trimethylolpropane, thereby lowering the weather-resistance of the coating layer.

### Comparative Example 3-2

Comparative Example 3-2 was similar to Example 3-1, and the differences in Comparative Example 3-2 were the reaction temperature being increased to 220° C., the reaction was performed under vacuum at 100 torr, and the reaction period being decreased to 9 hours. The types and amounts of the reactants were same as those in Example 3-1. Xylene was added to the reaction result to dilute it to a solid content of 75 wt %, which was analyzed by the standard CNS 15200-2-2 at room temperature (about 25° C.) to measure its Gardner-Holdt viscosity (Z, about 2300 cps). The polyester was analyzed by GPC with polystyrenes as standard to measure its weight average molecular weight (97406). The carbon spectrum (¹³C NMR) of the polyester was measured, which had a signal integral value C1 from 39 ppm to 40 ppm, a signal integral value C2 from 37 ppm to 39 ppm, and a signal integral value C3 from 33 ppm to 35 ppm. In Comparative Example 3-1, (C1+2*C2+3*C3)/(C1+C2+C3)=2.51. Because the reaction was processed under vacuum at high temperature, the degree of esterification (e.g. the degree of cross-linking) of the trimethylolpropane was too high, which resulted in the weight average molecular weight and viscosity of the polyester being too high.

20 g of a curing agent melamine (Allnex Cymel 303) and 37.5 g of TiO₂ (Chemours Ti-Pure R706) were added to 100 g of the polyester solution (having a solid content of 75 wt %), and then further diluted by xylene to form a coating material having a solid content of 75 wt %. The coating material was coated onto a galvanized steel plate, and then dried at 240° C. for 10 minutes to form a coating layer. The coating layer was tested by the standard CNS 10757 to measure its hardness (2H), and tested by ASTM D4145 to measure its T-bend resistance (1T).

### Comparative Example 3-3

Comparative Example 3-3 was similar to Example 3-1, and the differences in Comparative Example 3-3 were the reaction being performed under vacuum at 50 torr and the reaction period being decreased to 4 hours. The types and amounts of the reactants and the reaction temperature were same as those in Example 3-1. The reaction of the polyester was gel and could not be further used. The carbon spectrum (¹³C NMR) of the polyester was measured, which had a signal integral value C1 from 39 ppm to 40 ppm, a signal integral value C2 from 37 ppm to 39 ppm, and a signal integral value C3 from 33 ppm to 35 ppm. In Comparative Example 3-2, (C1+2*C2+3*C3)/(C1+C2+C3)=2.7. Because the reaction was performed under vacuum, the degree of esterification (e.g. the degree of cross-linking) of the trimethylolpropane was too high, which resulted in the reaction mixture gelled and failed to serve as a coating material.

### Comparative Example 4

30 g of trimethylolpropane (0.22 mole), 25 g of ethylene glycol (0.40 mole), 30 g of neopentyl glycol (0.29 mole), 70 g of 2-ethyl-2-butylpropanediol (0.44 mole), 190 g of phthalic anhydride (1.23 mole), and 0.3 g of tin(II) oxalate were mixed and then heated to 210° C. and reacted for 12 hours to form a polyester. Xylene was added to the reaction result to dilute it to a solid content of 75 wt %, which was analyzed by the standard CNS 15200-2-2 at room temperature (about 25° C.) to measure its Gardner-Holdt viscosity (Z5 to Z7, about 10000 cps to 25000 cps). The polyester was analyzed by GPC with polystyrenes as standard to measure its weight average molecular weight (4200).

20 g of a curing agent melamine (Allnex Cymel 303) and 37.5 g of TiO₂ (Chemours Ti-Pure R706) were added to 100 g of the polyester solution (having a solid content of 75 wt %), and then further diluted by xylene to form a coating material having a solid content of 75 wt %. The coating material was coated onto a galvanized steel plate, and then dried at 240° C. for 10 minutes to form a coating layer. The coating layer was tested by the standard ASTM G154 Cycle 2 to measure its weather-resistance (brightness kept as about 10% after being tested for 1000 hours). As shown above, if (d) aliphatic anhydride monomer was replaced with aromatic anhydride monomer, the coating layer would have a poor weather-resistance.

### Comparative Example 5

The commercially available polyester (5055 from Eternal Materials Co., Ltd, solid content=70 wt %) was condensed to have a solid content of 75 wt %, which was analyzed by the standard CNS 15200-2-2 at room temperature (about 25° C.) to measure its Gardner-Holdt viscosity (Z4 to Z6, about 6500 cps to 15000 cps). As shown above, the commercially available polyester could not form a coating material with a high solid content and a low viscosity.

20 g of a curing agent melamine (Allnex Cymel 303) and 37.5 g of TiO₂ (Chemours Ti-Pure R706) were added to 100 g of the polyester solution (having a solid content of 75 wt %), and then further diluted by xylene to form a coating material having a solid content of 75 wt %. The coating material was coated onto a galvanized steel plate, and then dried at 240° C. for 10 minutes to form a coating layer. The coating layer was tested by the standard ASTM G154 Cycle 2 to measure its weather-resistance (brightness kept as about 25% after being tested for 1000 hours).

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A polyester, formed by reacting a plurality of monomers, wherein the monomers include:
7 to 20 parts by mole of (a) aliphatic triol monomer;
40 to 80 parts by mole of (b) first diol monomer;
to 40 parts by mole of (c) second diol monomer; and
100 parts by mole of (d) aliphatic diacid monomer or aliphatic anhydride monomer,
wherein (b) first diol monomer has a chemical structure of 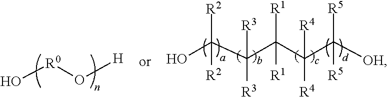
wherein n is an integer of 2 to 10,
each of a, b, c, and d is independently an integer of 0 to 6, and a+b+c+d≠0,
R⁰ is C₂₋₅ alkylene group;
R¹ is H or C₁₋₆ alkyl group, and each of R¹ is the same;
R² is H or C₁₋₆ alkyl group, and each of R² is the same;
R³ is H or C₁₋₆ alkyl group, and each of R³ is the same;
R⁴ is H or C₁₋₆ alkyl group, and each of R⁴ is the same; and
R⁵ is H or C₁₋₆ alkyl group, and each of R⁵ is the same; and
wherein (c) second diol monomer has a chemical structure of 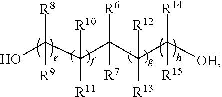
wherein each of e, f, g, and h is independently an integer of 0 to 6, and e+f+g+h≠0; and
R⁶ is H or C₁₋₆ alkyl group, R⁷ is H or C₁₋₆ alkyl group, and R⁶ is different from R⁷; and
each of R⁸, R⁹, R¹⁰, R¹¹, R¹², R¹³, R¹⁴, and R¹⁵ is independently H or C₁₋₆ alkyl group.

2. The polyester as claimed in claim 1, wherein (a) aliphatic triol monomer comprises glycerin, trimethylolpropane, trimethylolethane, polycaprolactone triol, stigmastane-3,5,6-triol, (5alpha)-cholestane-3,5,6-triol, or a combination thereof.

3. The polyester as claimed in claim 1, wherein (b) first diol monomer comprises ethylene glycol, propylene glycol, neopentyl glycol, 1,4-butanediol, diethylene glycol, dipropylene glycol, tripropylene glycol, or a combination thereof.

4. The polyester as claimed in claim 1, wherein (c) second diol monomer comprises 2-butyl-2-ethyl-1,3-propanediol, 1,2-propanediol, 1,3-butanediol, 2-methyl-2,4-petanediol, 2-methyl-2-propyl-1,3-propanediol, or a combination thereof.

5. The polyester as claimed in claim 1, wherein (d) aliphatic diacid monomer or aliphatic anhydride monomer comprises hydrogenated phthalic anhydride, dodecenylsuccinic anhydride, hexahydro-4-methylphthalic anhydride, methylsuccinic anhydride, itaconic anhydride, 2,3-dimethylmaleic anhydride, succinic acid, oxalic acid, malonic acid, glutaric acid, adipic acid, suberic acid, azelaic acid, sebacic acid, dodecanedioic acid, thapsic acid, itaconic acid or a combination thereof.

6. The polyester as claimed in claim 1, wherein (a) aliphatic triol monomer, (b) first diol monomer, (d) aliphatic diacid monomer or aliphatic anhydride monomer, or a combination thereof is a biomass material.

7. The polyester as claimed in claim 1, having a weight average molecular weight of 4500 to 90000.

8. The polyester as claimed in claim 1, being diluted in xylene to have a solid content of 75 wt %, and the diluted polyester has a Gardner-Holdt viscosity of Y to Z3 at 25° C.

9. The polyester as claimed in claim 1, having a signal integral value C1 from 39 ppm to 40 ppm in a carbon spectrum, a signal integral value C2 from 37 ppm to 39 ppm in the carbon spectrum, a signal integral value C3 from 33 ppm to 35 ppm in the carbon spectrum, and (C1+2*C2+3*C3)/(C1+C2+C3)=2.07 to 2.50.

10. A coating material, comprising:
100 parts by weight of the polyester as claimed in claim 1; and
5 to 40 parts by weight of a curing agent.

11. The coating material as claimed in claim 10, wherein the curing agent comprises melamine or isocyanate.

12. The coating material as claimed in claim 10, further comprising 10 to 30 parts by weight of a solvent.

13. The coating material as claimed in claim 12, wherein the solvent comprises xylene, toluene, aromatic naphtha, ethyl acetate, butyl acetate, methyl isobutyl ketone, acetone, tetrahydrofuran, cyclohexane, cyclohexanone, or a combination thereof.
